(19) United States
(12) Patent Application Publication
(10) Pub. No.: US 2024/0362578 A1
(43) Pub. Date: Oct. 31, 2024

(54) Supply Chain Product Identification Cross Reference System

(71) Applicant: Encompass Technologies, LLP, Fort Collins, CO (US)

(72) Inventors: William J. Kraich, Fort Collins, CO (US); Jonathan O'Neil, Fort Collins, CO (US); Tommy Riley, Davis, CA (US); Caden MacKenzie, Mill Valley, CA (US); Miles MacKenzie, Golden, CO (US); Max Grossenbacher, Hermosa Beach, CA (US); Blake Claude Harold Skipper, Fort Collins, CO (US)

(73) Assignee: Encompass Technologies, LLP, Fort Collins, CO (US)

(21) Appl. No.: 18/139,845

(22) Filed: Apr. 26, 2023

(51) Int. Cl. G06Q 10/087

(52) U.S. Cl. CPC G06Q 10/087

(57) ABSTRACT

A computer implemented supply chain cross reference system operates to increase product information flow associated with a plurality of products between a plurality of tiers in a supply chain.

### FIELD OF THE INVENTION

A computer implemented supply chain cross reference system and methods of making and using the computer implemented supply chain cross reference system to increase product information flow associated with a plurality of products between a plurality of tiers in the supply chain.

### BACKGROUND OF THE INVENTION

With the passage of the 21st amendment ending national prohibition, states were given the authority to regulate alcohol. The states developed a structure of checks and balances that provided safe alcohol to the consumer while ensuring a simple method to collect tax revenue.

This structure of checks and balance has become known as the three-tier system. The three-tier system allows manufacturers to provide alcoholic products to wholesalers, who distribute the alcoholic products to retailers, who sell the alcoholic products to the consumers. No one entity can be involved in more than one tier under most state models and each tier is regulated and licensed separately.

In toto, the three-tier system has been an effective method of alcohol regulation and distribution in the United States since the end of Prohibition. The structure creates important public health safeguards while streamlining the tax revenue process. Alcoholic products made unlawfully have a difficult time making it to the marketplace within the confines of this arrangement.

However, because no one entity is involved in more than one tier of the three-tier system, each manufacturer creates a unique identification number for each alcoholic product it carries. Each distributor creates a unique identification number for each alcoholic product it carries. Each retailer creates a unique identification number for each alcoholic product it carries. As between the manufacturer, the distributor, and the retailer, the unique identification numbers can all be different.

Additionally, use of the universal product code (“UPC”) fails to create consistent identification of each alcoholic product between the manufacturer, distributor and retailer. The UPC associated with an alcoholic product container can be the same for different stock keeping units (“SKU”), for example, single containers, package of six containers, or a case of containers. Moreover, seasonal reformulation of alcoholic products by the manufacturer can carry the same UPC. Similarly, in the wine sector, the same UPC may be used across all vintages. Thus, the UPC can be a very unreliable identifier between the manufacturer, distributor, and retailer.

As result of each tier within the three-tier system utilizing either the same product identifier for a variety of alcoholic products and/or utilizing a different product identifier for the same alcoholic product, each tier within the three-tier system can be blind as to the inventory of each alcoholic product at each other tier within the three-tier system. This can result in delays in transferring alcoholic products between the tiers of the three-tier system and unnecessary depletion of inventory in alcoholic products available at any one or more of the tiers within the three-tier system.

There would be a substantial advantage in a computer implemented system that allows one or more of the manufacturer, the distributor, or retailer to view the supply chain data on alcoholic products at each tier in the three-tier system would allow each tier to monitor current inventory and depletion of inventory for each alcoholic product at each tier in the three-tier system, and thereby, determine frequency and the amount of each alcoholic product to transfer between tiers in the three-tier system offset depletion of inventory for each alcoholic product at each tier within the three-tier system. The increase in information flow at each tier in the three-tier system can correspondingly increase product flow, increase financial flow, increase value flow, and decrease risk flow in the three-tier system.

### SUMMARY OF THE INVENTION

A broad object of embodiments of the invention can be to provide a computer implemented supply chain reference system including a processor communicatively coupled to a non-transitory computer readable medium containing a program code executable to access a product records database defined by a search query associated with a global product identifier to retrieve product records associated with a manufacturer product in each tier in a plurality of tiers in a supply chain. The retrieved product records in each tier in the plurality of tiers of the supply chain associate a plurality of entities in each of the plurality of tiers in the supply chain which supply the manufacturer product, the product records include a plurality of product attributes of each of the one or more entities associated with the manufacturer product. The computer program can function to cause display of a user interface which allows user interaction in the user interface to define a search query including one or more of the plurality of product attributes of one of the plurality of entities, wherein at least one of said plurality of product attributes associated with the global product identifier of said manufacturer product, and presenting in the user interface, based on the search query, a list of the plurality of entities in one or more or the plurality of tiers in the supply chain that supply the manufacturer product.

Another broad object of embodiments of the invention can be to provide a computer implemented supply chain reference system including a processor communicatively coupled to a non-transitory computer readable medium containing a program code executable to access a product records database defined by a search query associated with a global product identifier to retrieve product records associated with a manufacturer product in the retailer tier in a plurality of tiers in a supply chain. The retrieved product records in the retailer tier in the plurality of tiers of the supply chain associate a plurality of retailers in the supply chain which supply the manufacturer product to consumers, the product records include retail product data related to retail product inventory of each of the plurality of retailers associated with the manufacturer product. The program code can further operate to normalize the retailer product data from the plurality of retailers to a standard format across all the retailer product data. The retailer product data normalized to the standard format and matched to a global product data set allows implementation of a retailer product data user interface. The computer code is further executable to display in the retailer product data user interface one or more graphical control elements selectable by a user to structure a search query to search the retailer product data normalized to said standard format and matched to the global product data set. The computer code can be further executed to display retailer product inventory category fields and depict numeric product inventory values in each of said retailer product inventory category fields.

Another broad object of embodiments of the invention can be to provide a computer implemented supply chain reference system including a processor communicatively coupled to a non-transitory computer readable medium containing a program code executable to access a product records database defined by a search query associated with a global product identifier to retrieve product records associated with a manufacturer product in the retailer tier in a plurality of tiers in a supply chain. The retrieved product records in the retailer tier in the plurality of tiers of the supply chain associate a plurality of retailers in the supply chain which supply the manufacturer product to consumers, the product records include retail product attributes and retail product data related to retail product inventory of each of the plurality of retailers associated with the manufacturer product. The computer code can be further executed to depict a product order user interface including a product order search field fillable by user indications to display a list of manufacturer products associated with a retailer, wherein each manufacturer product in the list of manufacturer products associated with the retailer product attributes. The computer code can be further executed to associate with each manufacturer product in said list manufacturer products associated with the retailer a purchase order field fillable with a product purchase quantity. In particular embodiments, the program code can further depict retailer product data including retailer product inventory values. The submission of the product purchase quantity entered into the purchase order field causes an update of the retailer product data associated with the manufacturer product. In particular embodiments, the computer code can be further executed to depict a product history button associated with each manufacturer product in the list of manufacturer products, the product history button by user indications causes display of a product inventory and purchase table including retailer product inventory values and retailer purchase order values associated with prior calendar weeks or prior calendar days.

Naturally, further objects of the invention are disclosed throughout other areas of the specification, drawings, photographs, and claims.

### BRIEF DESCRIPTION OF THE DRAWINGS

FIG. 1 is a block diagram of an illustrative computer means, network means and computer-readable media which provides computer-executable instructions to implement an embodiment of a supply chain cross reference system.

FIG. 2 illustrates an example of user interface depicting an editable manufacture product record including a global product identifier matched to the manufacturer product and associated manufacturer product attributes.

FIG. 3 illustrates a first example of a user interface in which a plurality of different manufacturer products are all associated with one universal price code (UPC).

FIG. 4 illustrates a second example of a user interface in which a plurality of different manufacturer products are all associated with one universal price code (UPC).

FIG. 5 illustrates an example of user interface depicting an editable distributor product record including the global product identifier matched to the manufacturer product and associated distributor product attributes.

FIG. 6 illustrates an example of user interface depicting an editable retailer product record including the global product identifier matched to the manufacturer product and associated retailer product attributes.

FIG. 7 illustrates a particular embodiment of a retailer product data interface including one or more graphical control elements operable to structure a search query to filter and retrieve retailer product data matched to the search query.

FIG. 8 illustrates a particular embodiment of a product order user interface operable by user indications to retrieve and display in whole or in part a list of manufacturer products associated with the retailer associated with a purchase order field fillable with a product purchase quantity to purchase the manufacturer product.

FIG. 9 illustrates a product inventory and purchase table including retailer product inventory and retailer purchase orders of the manufacturer product over prior periods of time.

### DETAILED DESCRIPTION OF THE INVENTION

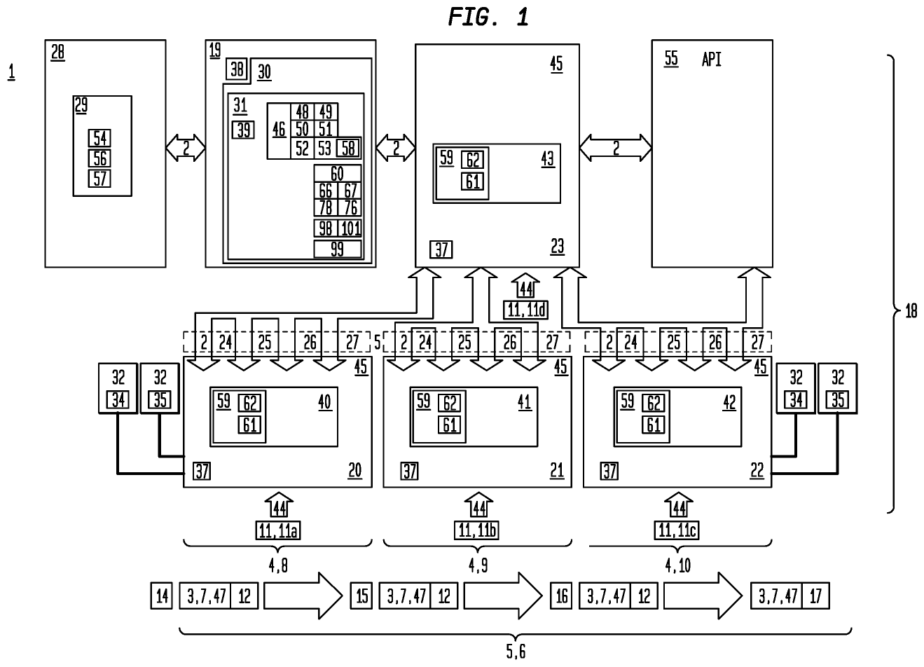

Generally, with reference to FIGS. 1 through 9, a supply chain cross reference system (1) (also referred to as the “system”) operates to increase product information flow (2) associated with a plurality of products (3) between a plurality of tiers (4) in a supply chain (5). While illustrative examples are provided in a three-tier supply chain (6); this is not intended to preclude embodiments of the system (1) useful to increase product information flow (2) in a supply chain (5) having a greater or lesser number of tiers (4). Additionally, while particular illustrative examples are provided in the context of alcoholic products (7) that flow in a three-tier supply chain (6); this is not intended to preclude embodiments of the system (1) in which other types or kinds of a plurality of products (3) flow between a plurality of tiers (4) of a supply chain (5). In particular, the system (1) can operate to increase product information flow (2) between the plurality of tiers (4) in a three-tier supply chain (6) of alcoholic products (7) including a manufacturer tier (8), a distributor tier (9), and a retailer tier (10). The product information flow (2) allows one or more user(s) (11) whether a manufacture user (11a), a distributor user (11b), a retailer user (11c) and/or an administrator user (11d) of the system (1) to monitor current product inventory (12) of each one of the plurality of products (3) and depletion of product inventory (12) of each the plurality of products (3) at each one of the plurality of tiers (4) in the three-tier supply chain (6) (or other multi-tier supply chain). The system (1) operates to increase information flow (2) even in the event that different product identifiers (13) are associated with each of a plurality of products (3) at each the plurality of tiers (4) within the three-tier system (6). The term “manufacturer (14)” as used for the purposes of this invention means an entity that makes, produces, or imports one or more products (3), and in the context of alcoholic products (7) includes, as examples: distillers, brewers, and wine makers. The term “distributor (15)” as used for the purposes of this invention means an entity that receives one or more products (3) from the manufacturer (14) and supplies products (3) to the retailer (16), and in the context of alcoholic products (7) includes as an example a wholesale liquor distributor. The term “retailer (16)” as used for the purposes of this invention means an entity that receives the product (3) from the distributor (15) and sells the product to consumers (17) that consume the products (3).

The Product Information Exchange Network. Generally, with reference to FIG. 1, particular embodiments of the invention can include a product information exchange network (18) which can be distributed on one or more servers (19) which operably couple, directly or indirectly, one or more manufacturer computing devices (20) and/or one or more distributor computing devices (21) and/or one or more retailer computing devices (22) to one or more supply chain administrator computing devices (23) by a public network (24), such as the Internet (25), a cellular-based wireless network(s) (26), or a local network (27) (individually or collectively a “network”).

In particular embodiments, the product information exchange network (18) can further include a product records database (28) from which product records (29) can be retrieved based on permissions by a request from the administrator computing device (23), the manufacturer computing devices (20), the distributor computing devices (21) or the retailer computing devices (22) to the extent the computing devices have network (24) or product records database (28) access privileges to retrieve product records (29) associated with a product (3) at one or more of the plurality of tiers (4) in the supply chain (5).

Again, with primary reference to FIG. 1, depicting illustrative computer hardware and network elements, including one more servers (19) having a non-transitory computer readable medium (30) containing a program code (31) which can be utilized to implement or practice embodiments of the system (1); however, it is not intended that embodiments of the invention be practiced in only in a wide area network (WAN) computing environments or only in local area network (LAN) computing environments, but rather the invention can be practiced in WAN or LAN computing environments or in distributed computing environments where functions or tasks are performed by remote processing devices that are linked through the network (24). In a distributed computing environment, program modules may be located in either one or both of WAN or LAN non-transitory computer readable medium (30).

Also, while a preferred embodiment of the invention may described in the general context of a program code (31) providing computer-executable instructions such as an application program and program modules which utilize routines, programs, objects, components, data structures, or the like, to perform particular functions or tasks or implement particular abstract data types, or the like, being executed by the computer hardware and network elements, it is not intended that any embodiments of the invention be limited to a particular set of computer-executable instructions or protocols.

Again, with primary reference to FIG. 1, the manufacturer computing devices (20), the distributor computing devices (21), the retailer computing devices (22), and the administrator computing devices (23) can be configured to connect with one or more server computers (19) through the public network (24) to transfer product records (29). The one or more manufacturer computing devices (20), the one or more distributor computing devices (21), the one or more retailer computing devices (22), and the one or more administrator computing devices (23) can, as examples, take the form of one or more limited-capability computers designed specifically for navigation in the system (1), or general capability computers, such as, desk top computers, hand-held computers, such as personal computers, slate or pad computers, cell phones, personal digital assistants, or the like.

In addition, each of the one or more manufacturer computing devices (20), the one or more distributor computing devices (21), the one or more retailer computing devices (22), and the one or more administrator computers (23) can further include peripheral input devices (32), such as: an image capture device (33), a video camera, a web camera, a mobile phone camera, a video phone, or the like, and an audio capture device (34), such as, microphones, speaker phones, computer microphones, or the like. The audio capture device (34) can be provided separately from or integral with the image capture device (33). The image capture device (33) and the audio capture device (34) can be integral or connected to the manufacturer computing device (20), the distributor computing device (21), the retailer computing device (22), and the administrator computing devices (23) by an image capture interface (35) and an audio capture interface (36).

Again, with primary reference to FIG. 1, each of the one or more manufacturer computing devices (20), the one or more distributor computing devices (21), the one or more retailer computing devices (22), and the administrator computing devices (23) can include an Internet browser (37) (also referred to as a “browser”) such as Google Chrome®, Mozilla®, Firefox®, or the like, which functions to download and render multimedia content that is formatted in “hypertext markup language” (HTML). In this environment, the server computer (19) can include a processor (38) communicatively coupled to a non-transitory computer readable medium (30) containing a program code (31) executed in part to implement the most significant portions of a graphical user interface module (39) to provide, based on access privileges of the corresponding manufacturer computing device (20), the distributor computing device (21) the retailer computing device (22), or the administrator computing device (23), a manufacturer user interface (40), a distributor user interface (41), a retailer user interface (42), and/or an administrator user interface (43).

As to these embodiments, the program code (31) including the graphical user interface module (39) which implements the manufacturer user interface (40), the distributor user interface (41), the retailer user interface (42), and/or the administrator user interface (43) can be resident in one or more servers (19) and/or the one or more manufacturer computing devices (20), the one or more distributor computing devices (21), the one or more retailer computing devices (22), or the administrator computing devices (23). The browser (37) can operate to download one or more of the user interfaces (40, 41, 42, 43) and to relay user inputs (44) back to the one or more server computers (19). In particular embodiments, the one or more servers (19) can respond by formatting new screen displays for the respective manufacturer user interface (40), distributor user interface (41), the retailer user interface (42) and the administrator user interface (43) and download them for display on the display surface (45) of the one or more manufacturer computing devices (20), the one or more distributor computing devices (21), retailer computing devices (22), or administrator computing devices (23).

In other embodiments, the one or more servers (19) can be used primarily as sources of product records (29), with primary responsibility for implementing the manufacturer user interface (40), the distributor user interface (41), the retailer user interface (42), and administrator user interface (43) being placed upon each of the one or more manufacturer computing devices (20), one or more distributor computing devices (21), the one or more retailer computing device (22), and the one or more administrator computing devices (23). As to these embodiments, each of the one or more manufacturer, distributor, retailer or administrator computing devices (20, 21, 22, 23) can contain and run the appropriate portions of the program code (31) implementing the manufacturer, distributor, retailer, or administrator user interfaces (40, 41, 42, 43). The manufacturer user (11a), the distributor user (11b), the retailer user (11c) or the administrator user (11c), may enter commands and information into a corresponding one or more manufacturer, distributor, retailer, or administrator computing devices (20, 21, 22, 23) through peripheral input devices (32) such as a keyboard or a pointing device, such as, a mouse; however, any method or device that converts user action into commands and information can be utilized including, but not limited to: a microphone, joystick, game pad, touch screen, or the like.

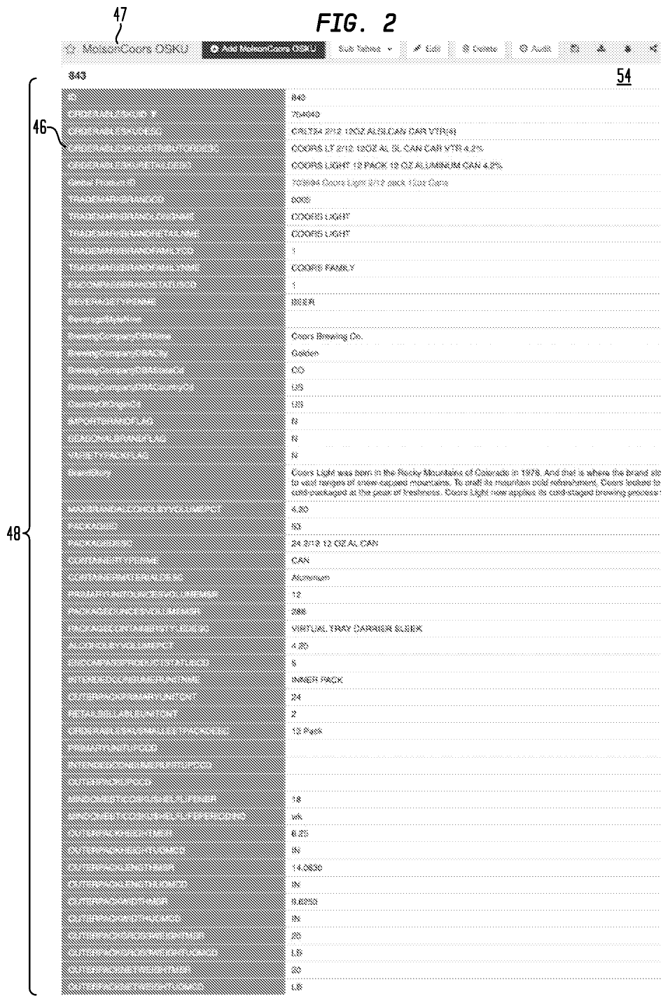

Supply Chain Cross Reference Interface. Now, with general reference to FIGS. 2 through 9, implementations of the present disclosure are described for implementing the user interfaces (40, 41, 42, 43) of the system (1) configured to allow a user (11a, 11b, 11c, 11d) (or other users (11) having permissions to use the system (1)) to create, store and retrieve product records (29) from one or more product records database(s) (28). The implementation associates a global product identifier (46) unique to each manufacturer product (47) of a manufacturer (14). In particular embodiments, the implementation associates a global product identifier (46) with a manufacturer product attributes (48) and manufacturer product data (49). The global product identifier (46) can then be associated with distributor product attributes (50) and distributor product data (51) for the same manufacturer product (47). The global product identifier (46) can then be associated with retailer product attributes (50) and retailer product data (51) for the same manufacture product (47).

Thus, the association of the global product identifier (46) to the manufacturer product attributes and data (48, 49) and the corresponding distributor product attributes and data (50, 51) and the corresponding retailer product attributes and data (52, 53) allows any of a plurality of users (11a, 11b, 11c, 11d) at any one of the plurality of tiers (4) in the supply chain (5) to access an product information flow (2) in the supply chain (5) relevant to each manufacturer product (47) in the context of the manufacturer, distributor, and/or retailer product attributes (48, 50, 52) and manufacturer, distributor, and/or retailer product data (49, 51, 53). Accordingly, at each of the plurality of tiers (4) in the supply chain (2) any user (11a, 11b, 11c, 11d) can change the product attributes (48, 50, 52) and/or the product data (49, 51, 53) based on permissions in the system (1) and any user (11a, 11b, 11c, 11d) can still access the product attributes (48, 50, 52) and/or product data (49, 51, 53) for a manufacturer product (47). The term “product attributes (48, 50, 52)” means for the purpose of this invention: any product identification information that can be associated, without loss of connection, to the global product identifier, and without limitation to the breadth of the foregoing can include one or more of: a product identifier, a UPC, a product image, a product name, and a product description. The term “product data (49, 51, 53)” means product supply information within any one of a plurality of tiers (4) in the supply chain (5) that can be associated, without loss of connection, to global product identifier (46), and without limitation to the breadth of the foregoing, includes one or more of inventory data, shipment data, sales data, for each manufacturer product (47) even if a plurality of manufacture products (47) share one or more common product data attributes (48, 50, 52).

As an illustrative example, for a plurality of manufacturer products (47) that may utilize one or more of the same product attributes (48, 50, 52) (such as a the same UPC) for different seasonal products, different vintages, or specialized products, the system (1) can maintain a novel discrete global product identifier (46) for each one of the different manufacture products (47) associated with the discrete product attributes (48, 50, 52) and the discrete product data (49, 51, 53). Implementation of the supply chain cross reference system (1) can increase product information flow (2) between a plurality of tiers (4) in the supply chain (5) which can translate into greater accuracy in the manufacturer product shipment frequency and amount being transferred between the plurality of tiers (4) in the supply chain (5). Use of the system (1) can substantially increase total sales of manufacturer products (47) at the retail tier (10).

Now, with primary reference to FIG. 2, which illustrates a particular implementation of an embodiment of particular user interface (40, 41, 42 or 43) depending on permissions in the system (1) depicting a manufacturer product record (54). The manufacturer product record (54) illustrates the association between the global product identifier (46) and the manufacturer product (47) and the associated manufacturer product attributes (48). In the illustrative example of FIG. 2, the manufacturer product record (54) illustrates the association of the manufacturer (14) (in this example, Molson Coors) to a manufacturer product (47) (in this example, Coors Light Beer) along with the manufacturer product attributes (48) (in this example the SKU, ORDERABLESKUID 704040) and other particular manufacturer product attributes (48) (such as, Coors LT 2/12 12 OZ AL SL CAN CAR VTR 4.2%). In this example, the manufacturer product (47) and the manufacturer product attributes (48) are associated with the global product identifier (46) (in the example of FIG. 2 “703694 Coors Light 2/12 pack 12 oz cans). A user (11) by user interaction in the user interface (40, 41, 42 or 43), or by operation of an application interface (55), can populate or edit the manufacturer product record (54) with the manufacturer product attributes (48) to be associated with the global product identifier (46). The populated manufacturer product record (54) can be saved in the product record database (28) associated with the global product identifier (46).

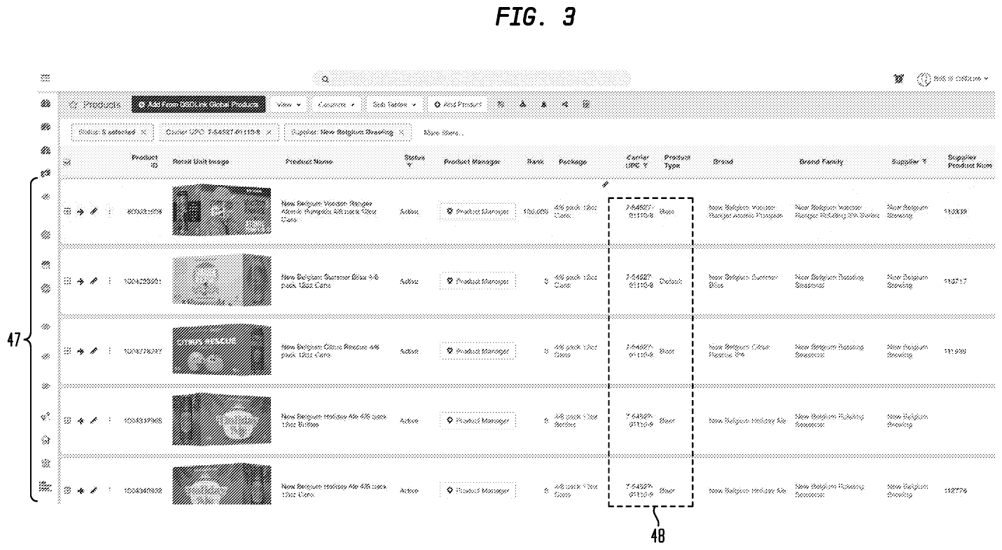

Now, with primary reference to FIG. 3, which illustrates that a manufacturer (14) can create a plurality of different manufacturer products (47) all associated with the same manufacturer product attributes (48) (in the example, using the same one UPC). In the illustrative example, the manufacturer (14) (New Belgium) associates five different manufacturer products (47) (seasonal flavors of an ale) with the same manufacture product attribute (48) (UPC 7-5452701110-9). Accordingly, in this example simply associating the manufacturer (14), distributor (15), or retailer (16) SKU with the UPC would not allow each of the plurality of tiers (4) in the supply chain (5) to differentiate between these different manufacturer products (47). Again, with reference to FIG. 2, to allow each of the plurality of tiers (4) in the supply chain (5) to retrieve product data (49, 51, 53) for each different manufacturer product (47), even if a plurality of manufacturer products (47) share certain manufacturer product attributes (48), such as a common UPC, a manufacturer product record (54) can be created for each different manufacturer product (47) including the relevant product attributes (48), and then associate each different manufacturer product (47) with a novel a global product identifier (46).

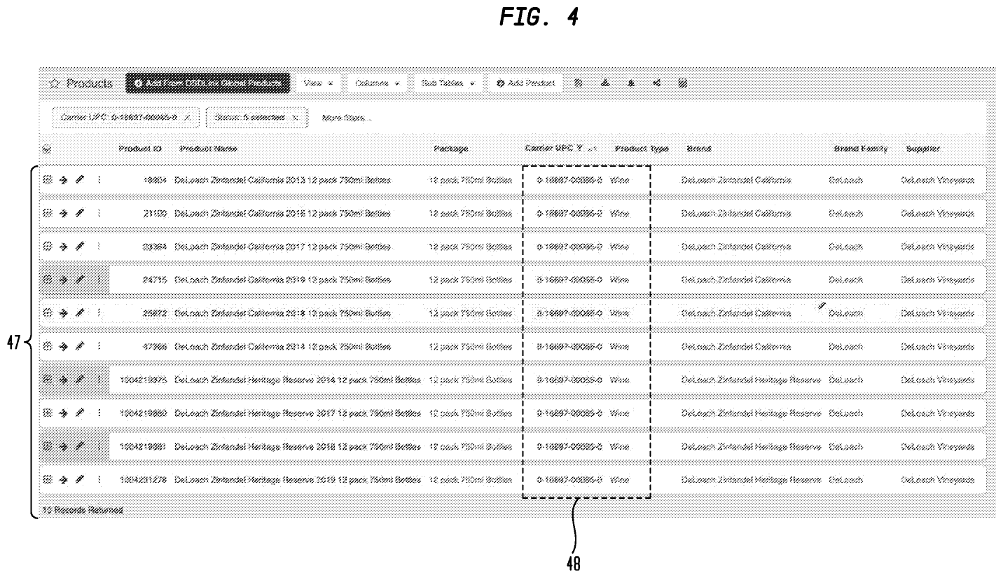

Now, with primary reference to FIG. 4, which further illustrates create a plurality of different manufacturer products (47) all associated with the same manufacturer product attributes (48) (in this case having the same one UPC). In the illustrative example, the manufacturer (47) DeLoach Winery associates ten different manufacturer products (47) (vintages of wine with the same UPC 0-16697-00065-0). Again, with reference to FIG. 2, to allow each of the plurality of tiers (4) in the supply chain (5) to retrieve product data (49, 51, 53) for each different manufacturer product (47), even if a plurality of manufacturer products (47) share certain manufacturer product attributes (48), such as a common UPC, a manufacturer product record (54) can be created for each different manufacturer product (47) including the relevant product attributes (48), and then associate each different manufacturer product (47) with a novel a global product identifier (46).

The illustrative examples of FIGS. 3 and 4, evidence that manufacturer product attributes (48) (in these examples, the UPC) can be an unreliable even in the manufacturer tier (8) in a supply chain (5) including a plurality of tiers (4).

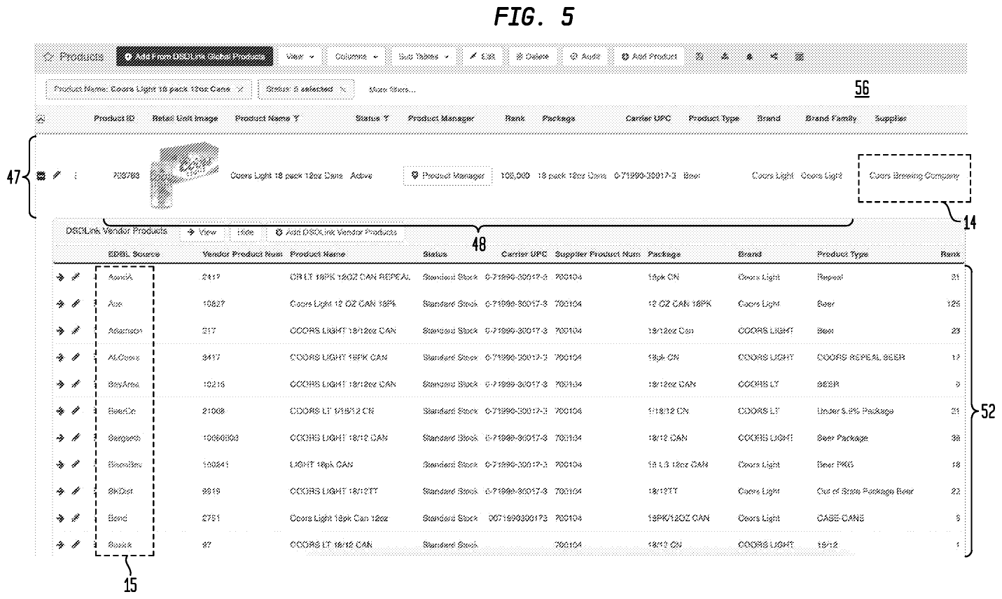

Now, with primary reference to FIG. 5, which illustrates a particular implementation of an embodiment of particular user interface (40, 41, 42 or 43) depending on permissions in the system (1) depicting a distributor product record (56). The distributor product record (56) associates the global product identifier (46) with the distributor product attributes (50) associated with the manufacturer product (47). In the illustrative example, a user (11a, 11b, 11c, 11d) can retrieve the global product identifier (46) (in the example of FIG. 5 “703763”) associated with a manufacturer product (47) (in the example of FIG. 5 “Coors Light 18 pack 12 oz cans . . . 0-71990-30017-3 . . . beer”) in a distributor product record (56). The user (11a, 11b, 11c, 11d) by user interaction in the user interface (40, 41, 42 or 43), or by operation of an application interface (55), can populate or edit the distributor product record (56) with the distributor product attributes (50) to be associated with the global product identifier (46) (in the example, the distributor name, distributor product identifier, distributor product name, carrier UPC, manufacturer product identifier, package description). The completed distributor product record (56) can be saved in the product record database (28) associated with the global product identifier (46).

Again, with primary reference to FIG. 5, a particular implementation of the user interface (40, 41, 42 or 43) in the distributor tier (9), allows by user interaction in the user interface (40, 41, 42 or 43) to enter or retrieve a global product identifier (46). The user (11a, 11b, 11c, 11d) by further user interaction in the user interface (40, 41, 42 or 43) can further request a list of all distributor product records (56) associated with the entered and retrieved global product identifier (46). In the illustrative example, the global product identifier (46) entered or retrieved “703763” causes the system to retrieve a list of all the distributors (15) that distribute the manufacturer product (47) (Molson Coors product 700104) along with the relevant distributor product attributes (50). As an illustrative example, distributor AandA associated with the manufacturer product 700104 retrieves AandA distributor product attributes (50) including distributor product identifier 2417 and CR LT 18 PK 12 OZ CAN REPEAL. By way of illustrative contrast, distributor Ace associates the manufacturer product 700104 with Ace product attributes (50) including the distributor product identifier 10827 and Coors Light 12 OZ CAN 18 Pk. In the twelve distributor product records (56) depicted in FIG. 5 none of the twelve distributor product records (56) in the distributor tier (9) of the supply chain (4) share any common distributor product attributes (50). Thus, the system (1) allows a user (11a, 11b, 11c, 11d) at any of a plurality of tiers (4) in the supply chain (5) having the proper permissions to readily identify all the distributors (15) in the distributor tier (9) of a supply chain (5) associated with the distribution of a particular manufacturer product (47) by retrieval or entry of the global product identifier (46).

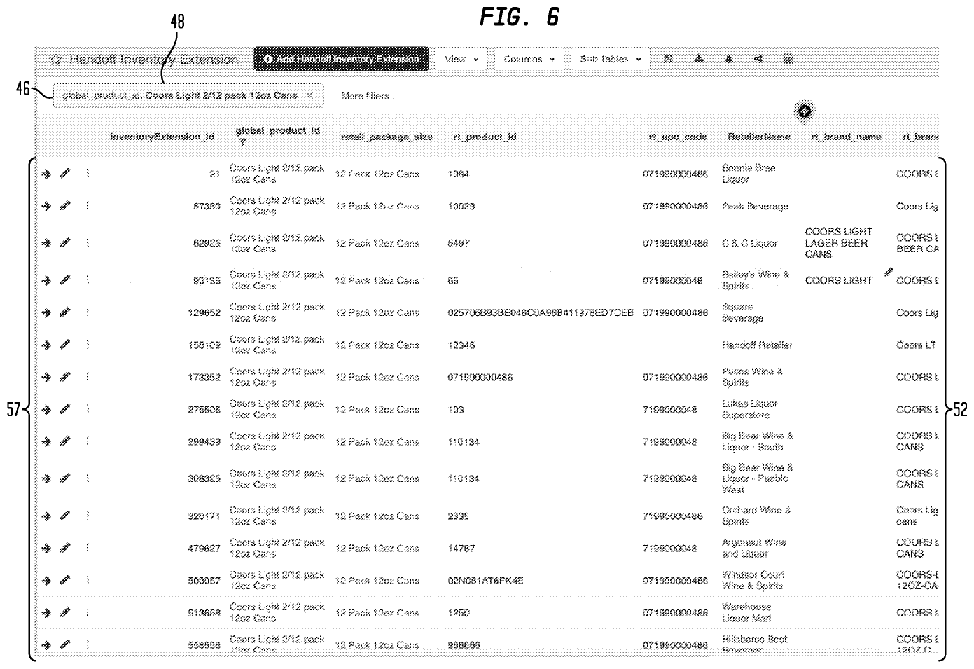

Now, with primary reference to FIG. 6, which illustrates a particular implementation of an embodiment of particular user interface (40, 41, 42 or 43) depending on permissions in the system (1) depicting a list of retailer product records (57). The retailer product records (57) associates the global product identifier (46) with the retailer product attributes (52) associated with the manufacturer product (47). In the illustrative example of FIG. 6, the user (11a, 11b, 11c, 11d) retrieves the global product identifier (46) (in the example of FIG. 6 “703694”) along with relevant manufacturer product attributes (48) associated with the global product identifier (46) (in the example of FIG. 5 “Coors Light 2/12 pack 12 oz cans”). The user (11a, 11b, 11c, 11d) by user interaction in the user interface (40, 41, 42 or 43), or by operation of an application interface (55), then populates the retailer product attributes (52) to be associated with the global product identifier (46) (in the example of FIG. 6 the retailer name, retailer product identifier, retailer product name, carrier UPC, retailer package description). Each completed retailer product record (57) can be saved in the product record database (28) associated with the global product identifier (46).

Again, with primary reference to FIG. 6, the particular implementation of the user interface (40, 41, 42 or 43) can by user interaction enter or retrieve a global product identifier (46). The user (11a, 11b, 11c, 11d) by further user interaction in the user interface (40, 41, 42 or 43) can further request a list of all of the retailer product records (57) associated with the entered or retrieved global product identifier (46). In the illustrative example of FIG. 6, the global product identifier (46) entered or retrieved “703694” causes the system to retrieve a list of all the retailers (16) that retail the manufacturer product (48) (in this example, Molson Coors 700104 along with the relevant retailer product attributes (52)). As an illustrative example, retailer (16) Bonnie Brae Liquor associates the manufacturer product 700104 with the retailer product attributes (52) including identifier 1084 and “Coors Light”. By way of illustrative contrast, retailer Square Beverage associates the manufacturer product 700104 with retailer product attributes (52) including identifier 025706B93BE046C0A96B411947ED7CEB and Coors Light. In the fifteen retailer product records (57) depicted in FIG. 6 none of the fifteen retailer product records (57) in the retailer tier (10) of the supply chain (5) share a common retailer product attribute (52). Thus, the system (1) allows a user (11a, 11b, 11c, 11d) at any one of the plurality of tiers (4) in the supply chain (5) having the proper permissions to readily identify all the retailers (16) in the retailer tier (10) of a supply chain (5) associated with the distribution of a particular manufacturer product (47) by retrieval or entry of the global product identifier (46).

Now, with primary reference to FIG. 1, a particular implementation of the retailer tier (10) in the system (1) can include an application interface (55) which applies defined rules that enables the retailer tier (10) to transfer retailer product data (53) to the database (28) and corresponding allows presentation of the retailer tier product inventory data (58) in one or more of user interfaces (40, 41, 42 or 43) as a retailer product data interface (59). The transfer of retailer product data (53) can also be accomplished by one or more of: traditional file transfer protocol, secure file transfer protocol, AS2 connection, email, local software, or manual export of retailer product data. Once the retailer product data (53) has been stored, the program code (31) can operate to normalize the retailer product data (53) from a plurality of retailers (16) to a standard format across all the retailer product data (53). The normalized retailer product data (53) can then be matched to a global product data set (60) that allows implementation of retailer product data interface (59) that allows a user (11a, 11b, 11c, 11d) having proper permissions to query the product record database (28) for retailer tier inventory data (58) matched to the global product data set (59).

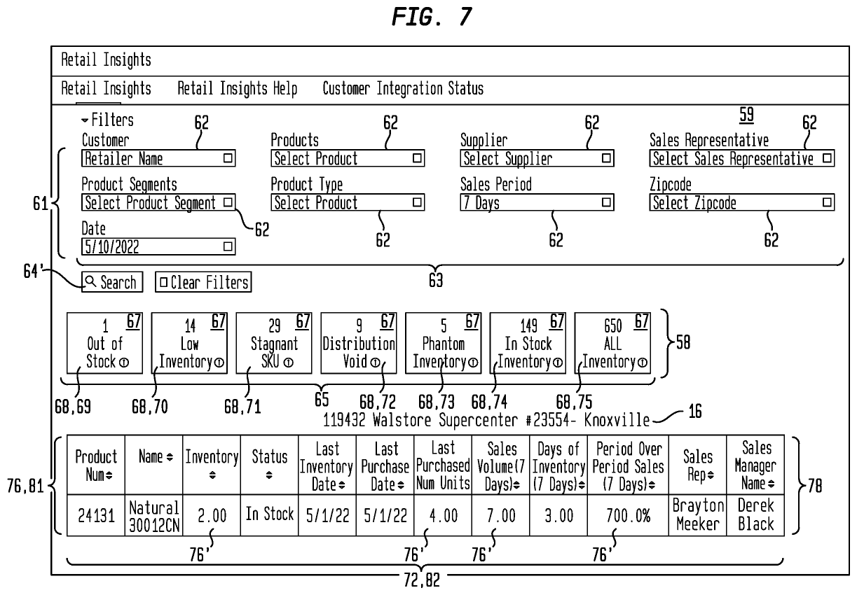

Now, with primary reference to FIG. 7, a particular implementation of the program code (31) can include a retailer product data interface (59) which can be useful to users (11a, 11b, 11c, 11d) at any of the plurality of tiers (4) in the supply chain (5). In the illustrative example, a user (11a, 11b, 11c, 11d) having proper permissions can by user indications in one or more graphical control elements (61) in the retailer product data interface (59) structure a search query (64) to filter and retrieve retailer product data (53) matched to the search query (64). The graphical control elements (61) can implement drop down lists (62) in one or more of a plurality of fields (63) to construct the search query (64) (as shown in the example of FIG. 7 the dropdown lists (62) include one or more of: Customers, Products, Manufacturer, Sales Representative, Product Segment, Product Type, Sales Period, Zip Code and Date). Once the search query (64) is constructed, a user (11a, 11b, 11c, 11d), by user interaction with a Search Button (64′), can implement the search of all retailer product data (53) in the database (28). The search can return retailer tier inventory data (58) retrieved in response to the search query (64), can by operation of the program code (31), be further analyzed against programmed defined inventory categories (65). In the illustrative example of FIG. 7, the computer defined inventory categories (65) are: Out of Stock, Low Inventory, Stagnant SKU, Distribution Void, Phantom Inventory, In Stock Inventory, and All Products. By further operation of the program code (31) the retailer tier inventory data (58) matched to each inventory category (65) can be compared to inventory category threshold values (66) to generate inventory data numeric values (67) associated with each inventory category (65) in excess of the preset inventory threshold value (66). The inventory data numeric values (67) can be displayed in corresponding inventory category field (68) in the retailer product data interface (59). In the example of FIG. 7, the inventory category fields (68) include: an Out of Stock field (69), a Low Inventory field (70), a Stagnant SKU field (71), a Distribution Void field (72), Phantom Inventory field (73), an In Stock Inventory field (74), and an All Products field (75) which are populated with inventory data numeric values (67) consistent with the scope of the search query (61). In particular embodiments, by user indication in a inventory category field (68) the program code (31) can operate to display one or more inventory tables (76) in which the retailer tier inventory data (58) allocated to a selected inventory category field (68) within the scope of the search query (64) can be further analyzed to generate subcategory product data numeric values (76′) and further display subcategory data cells (77) within the inventory table (76) in which subcategory retail tier inventory data (78) can be depicted.

In the illustrative example of FIG. 7, the search query (64) included only the name of a retailer (16) (19432 Walmart Supercenter #2835—Knoxville) which was searched and returned the inventory data numeric values (67) shown in each inventory category field (68). In the illustrative example, the In Stock field (69) was populated with the inventory data numeric value (67) (in the example, “1”). By user (11a, 11b, 11c, 11d) indications in the retailer product data interface (59), the “In Stock” field (74) was selected to generate the In Stock inventory table (79) including one table row including the In Stock subcategory cells (80) including the subcategory retail tier inventory data (78) and/or subcategory inventory data numeric values (76′) allocated to each subcategory data cell (77) including the In Stock subcategory cells (80): Product Number, Product Name, Current Inventory, Status, Last Inventory Date, Last Purchase Date, Last Purchased No. of Units, Sales Volume (7 days), Days of Inventory (7 days), Period over Period Sales (7 days), Sales Representative Name, Sales Manager Name.

In a further illustrative example shown in FIG. 7, by user indications in the a retailer product data user interface (59), the “Out of Stock” field (69) was selected to generate the “Out of Stock” inventory table (81) including the “Out of Stock Inventory” subcategory cells (82) including the subcategory retail tier inventory data (78) allocated to each of a plurality of subcategory cells (82) including: Product Number, Product Name, Current Inventory, Status, Last Inventory Date, Last Purchase Date, Last Purchased No. of Units, Sales Volume (7 days), Days of Inventory (7 days), Period over Period Sales (7 days), Sales Representative Name, Sales Manager Name.

Similarly, by user indications in the “Stagnant SKU” field (71), the program code (31) can function to generate an inventory table (76) including subcategory retail tier inventory data (78) associated with Current Inventory that remained in excess of a threshold numeric value for more than a threshold number of days.

Similarly, by user indications in the “Distributor Void” field, the program code can function to generate an inventory table (76) including subcategory retail tier inventory data (78) for the products that have not been replenished over a threshold numeric value for more than a threshold number of days.

Similarly, by user indications in the “Phantom Inventory” field, the program code can function to generate an inventory table (76) including subcategory inventory data for the products that appear to be associated with incorrect product inventory data. For example, the product name associated with the inventory data is not correct.

Similarly, by user indications in the “In Stock Inventory” field, the program code can function to generate an inventory table (76) including a table row for each product that the retailer (16) stocks.

There can be a substantial advantage for manufacturer users (11a) and distributor users (11b) in utilizing the retailer product data interface (59) in that retailer product data (53) can be filtered by retailer (16) or retailer and manufacturer product (47) to display inventory data numeric values (67) for each one of a plurality of manufacturer products (47) stocked by each one of a plurality of retailers (16). Thus, the distributor user (11b) does not have to count physical inventory at the retailer's business location to know inventory data numeric values (67) for each of the plurality of manufacturer products (47) stocked by each of a plurality of retailers (16). This product information flow (2) can reduce the lag time to replenish inventory between the manufacturer (14) and the distributor (15) and the distributor (15) and the retailer (16).

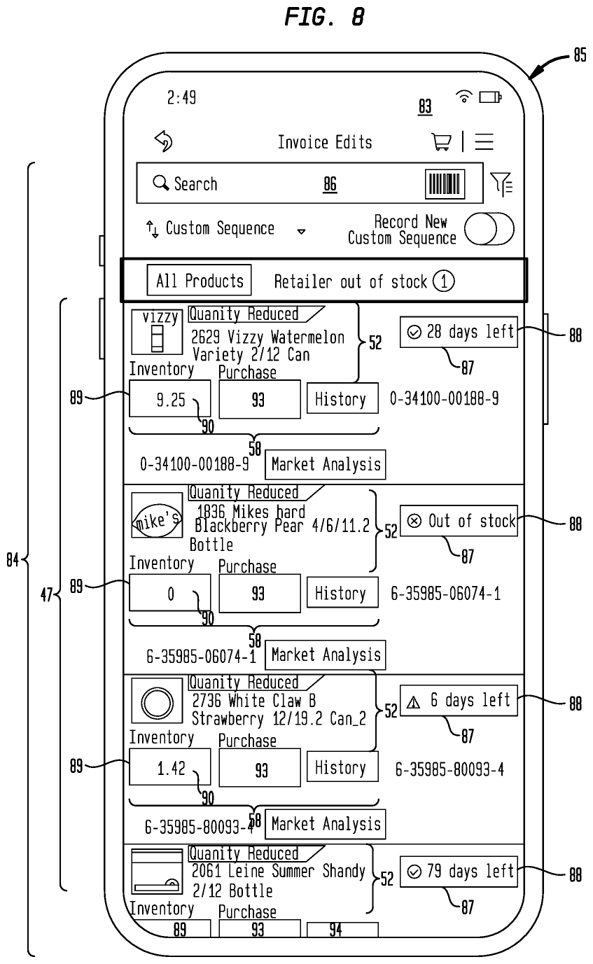

Now, with primary reference to FIG. 8, embodiments can further include a product order user interface (83) depicted on a distributor computing device (21) or the retailer computing device (22). The program code (31) can further operate to reformat the product retailer tier inventory data (58) to populate a product order form (84) depicted on the distributors computing device (21) or the retailer computing device (22). As shown in the illustrative example of FIG. 8, an embodiment of the product order user interface (83) is shown as a depiction on a mobile cell phone (85) with access to a cellular radio system allowing the product order user interface (83) to be used without a physical connection to a network. The illustrative product order user interface (83) includes product order search field (86) allowing the user (in the example: 11b, 11c) to enter a retailer (16) to retrieve and display in whole or in part a list of manufacturer products (47) associated with the retailer (16). As shown by the illustrative example, each manufacturer product (47) can be depicted with, in whole or in part, retailer product attributes (52) and retailer product data (53). In particular embodiments, the program code (31), can further operate based on retailer tier inventory data (58) prior submitted in the system (1) to calculate and estimated a period in days that will elapse until the manufacturer product (46) will be depleted (out of stock) at the associated retailer (16). The program code (31) can further operate to depict a product inventory depletion field (87), and further operate to populate the product inventory depletion field (87) with a numeric period in days (88) until the manufacturer product (47) becomes depleted (out of stock). In particular embodiments, the program code (31) can further operate to depict a current product inventory field (89) for each listed manufacturer product (47) and populate the current product inventory field (89) with a product inventory numeric value (90). In the illustrative example, for manufacturer product (47) (1836 Mikes Hard Blackberry Pear Apr. 6, 2011—2 bottle) the program code (31) has calculated the numeric period of days (88) to exhaustion of the manufacturer product (47) and has populated the “product exhaustion field” with “out of stock” and correspondingly calculated the product inventory (12) and populated the current inventory field (89) with the numeric current retailer product inventory of “0”. As another illustrative example, for manufacturer product (47) (2629 Vizzy Watermelon Variety 2/12 Can) the program code (31) has calculated the numeric period of days (88) to exhaustion of the current product inventory (12) and has populated the “product exhaustion field” with “28 days left” and correspondingly calculated the current product inventory (12) and populated the current product inventory field (89) with the numeric current retailer product inventory of “9.25”. In particular embodiments, program code (31) further operates to depict a purchase order field (91) which by user indications in the product order user interface (83) can be filled with a product purchase quantity (92). In the illustrative example, the manufacturer product (47) (1836 Mikes Hard Blackberry Pear Apr. 6, 2011—2 bottle) is depicted as being “out of stock” and “current inventory” being “0”. The distributor user (11b) or the retailer user (11c) can by user indications in the product order user interface (83) enter the product purchase quantity (93) (in the example, “10” has been entered into the purchase order field (91).

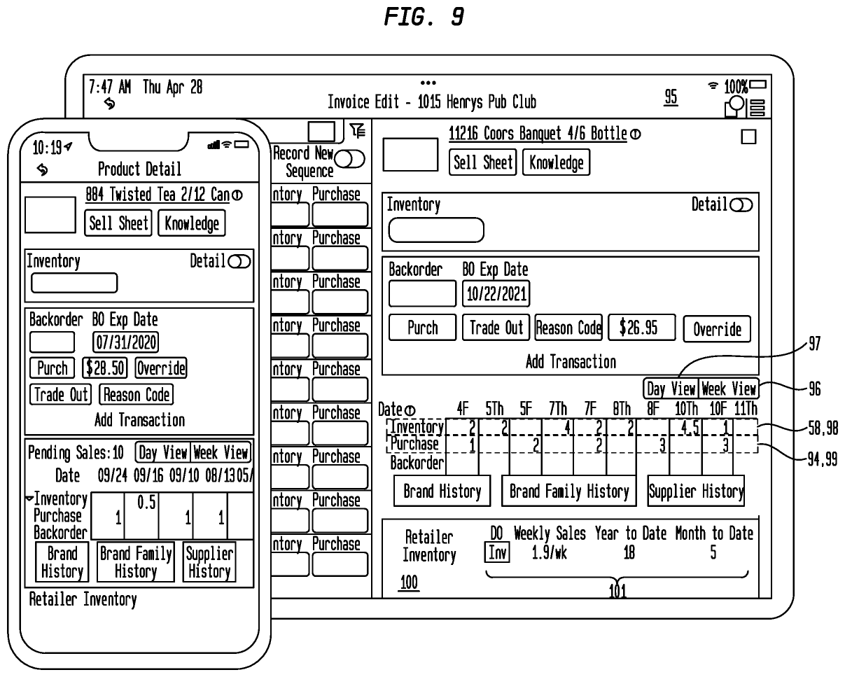

Now, with primary reference to FIG. 9, in particular embodiments, the program code (31) can further depict a product history button (94) (in the example of FIG. 8 “History” button) associated with each listed manufacturer product (47) carried by a retailer (16). By user selection of the product history button (94), the program code (31) functions to display a product inventory and purchase table (95) including retailer tier inventory (58) and retailer purchase orders (94) of the manufacture product (47) by activating a calendar week button (96) or a calendar day button (97) to depict retailer product inventory values (98) and retailer purchase order values (99) in prior calendar weeks or prior calendar days. In particular embodiments, program code (31) can function to depict a retailer product sales table (100) which depicts retailer product sales values (101) week to date, month to date, and year to date.

The retailer tier inventory data (58) presented in the a product inventory and purchase table 95) and/or the retailer product sales table (100) provides a substantial advantage for the distributor user (11b) or the retailer user (11c) in having immediate access to retailer product data (58) relating to the rate of change in the retailer product inventory values (98), retailer product purchase order values (99), and retailer product sales (101) over time, and thus allowing a prediction of the product purchase quantity (93) to enter into the purchase order field (91). By submission of the completed retailer product order (94) by the distributor user (11b) or the retailer user (11c), the distributor user (11b) and/or the retailer user (11c) has immediate notice of the product purchase quantity (92) for each manufacturer product (47) associated with the retailer (16). Additionally, the retailer product data (58) for each of the manufacturer products (47) can be updated in the retailer product records (57) in the database (28) allowing each of the plurality of tiers (4) in the supply chain (5) to know the current demand for each manufacturer product (47) in the supply chain (5).

As can be easily understood from the foregoing, the basic concepts of the present invention may be embodied in a variety of ways. The invention involves numerous and varied embodiments of a supply chain cross reference system (1) and methods for making and using such supply chain cross reference system (1) including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “distributor” should be understood to encompass disclosure of the act of “distributing”—whether explicitly discussed or not—and, conversely, were there is a disclosure of the act of “distributing”, such a disclosure should be understood to encompass disclosure of a “distributor” and even a “means for distributing”. Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Further, for the purposes of the present invention, the term “coupled” or derivatives thereof can mean indirectly coupled, coupled, directly coupled, connected, directly connected, or integrated with, depending upon the embodiment.

Additionally, for the purposes of the present invention, the term “integrated” when referring to two or more components means that the components (i) can be united to provide a one-piece construct, a monolithic construct, or a unified whole, or (ii) can be formed as a one-piece construct, a monolithic construct, or a unified whole. Said another way, the components can be integrally formed, meaning connected together so as to make up a single complete piece or unit, or so as to work together as a single complete piece or unit, and so as to be incapable of being easily dismantled without destroying the integrity of the piece or unit.

Thus, the applicant(s) should be understood to claim at least: i) each of the computer implement supply chain cross reference systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The elements following an open transitional phrase such as “comprising” may in the alternative be claimed with a closed transitional phrase such as “consisting essentially of” or “consisting of” whether or not explicitly indicated the description portion of the specification.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

We claim:

1. A supply chain cross reference system comprising:
a processor communicatively coupled to a non-transitory computer readable medium containing a computer code executable to:
access a product records database defined by a search query associated with a global product identifier to retrieve product records associated with a manufacturer product in each tier in a plurality of tiers in a supply chain, wherein said retrieved product records in each tier in said plurality of tiers of said supply chain associate a plurality of entities in each tier of the plurality of tiers in said supply chain which supply said manufacturer product, wherein said product records include a plurality of product attributes of each of said one or more entities associated with said manufacturer product;
causing display of a user interface which allows user interaction in said user interface to define a search query including one of said plurality of product attributes of one of said plurality of entities, said one of said plurality of product attributes associated with said global product identifier of said manufacturer product; and
presenting in said user interface, based on said search query including said one of said plurality of product attributes of said one of said plurality of entities, a list of said plurality of entities in one or more or said plurality of tiers in said supply chain that supply said manufacturer product, wherein each of said plurality of entities in said list associated with said plurality of product attributes associated with said manufacturer product.

2. The system of claim 1, wherein said user comprises a manufacturer of said manufacturer product in a first tier of said plurality of tiers in said supply chain.

3. The system of claim 1, wherein said user comprises a distributor of said manufacturer product in a second tier of said plurality of tiers in said supply chain.

4. The system of claim 1, wherein said user comprises a retailer of said manufactured product in a third tier of said plurality of tiers in said supply chain.

5. The system of claim 1, wherein said product record comprises a manufacturer product record which depicts said global product identifier associated with said manufacturer product, and wherein said plurality of product attributes comprise a plurality of manufacturer product attributes associated with said manufacturer product.

6. The system of claim 1, wherein said product record comprises a distributor product record which depicts said global product identifier associated with said manufacturer product, and wherein said plurality of product attributes comprise a plurality of distributor product attributes associated with said manufacturer product.

7. The system of claim 1, wherein said product record comprises a retailer product record which depicts said global product identifier associated with said manufacturer product, and wherein said plurality of product attributes comprise a plurality of retailer product attributes associated with said manufacturer product.

8. The system of claim 1, wherein retrieved product records in a retailer tier of said supply chain associate a plurality of retailers which supply said manufacturer product with said global product identifier, wherein said product records of said plurality of retailers further include retailer product data associated with said manufacturer product.

9. The system of claim 8, wherein computer code further executable to normalize said retailer product data from said plurality of retailers to a standard format across all said retailer product data.

10. The system of claim 9, wherein said computer program further executable to match said retailer product data normalized to said standard format and matched to a global product data set that allows implementation of a retailer product data user interface.

11. The system of claim 10, wherein said computer code further executable to display in said retailer product data user interface including one or more graphical control elements selectable by a user to structure a search query to search said retailer product data normalized to said standard format matched to said global product data set.

12. The system of claim 11, wherein retailer product data normalized to said standard format and matched to said global product data set defines one or more retailer product inventory categories.

13. The system of claim 12, wherein said computer code further executable to allocate said retailer product data normalized to said standard format matched to said global product data set said one or more to retailer product inventory categories.

14. The system of claim 13, wherein said computer code further executable to calculate numeric product inventory values corresponding to each of said retailor product inventory categories.

15. The system of claim 14, wherein said computer code further executable to: display product inventory category fields in said retailer product data user interface; and depict said numeric product inventory values in each of said retailer product inventory category fields.

16. The system of claim 15, wherein said computer code further executable to depict a product order user interface including a product order search field fillable by user indications to display a list of manufacturer products associated with said retailer, wherein each manufacturer product in said list of manufacturer products associated with retailer product attributes.

17. The system of claim 16, wherein said computer code further executable to associate with each manufacturer product in said list manufacturer products associated with said retailer a purchase order field fillable with a product purchase quantity.

18. The system of claim 17, wherein said computer code further executable to depict a product history button associated with each manufacturer product in said list of manufacturer products, said product history button by user indications causes display of a product inventory and purchase table including retailer product inventory values and retailer purchase order values associated with prior calendar weeks or prior calendar days.
